(19) United States
(12) Patent Application Publication
(10) Pub. No.: US 2026/0252814 A1
(43) Pub. Date: Aug. 27, 2026

(54) METHODS AND SYSTEMS OF ASSESSING A REPRESENTATION OF A BRAND IN LANGUAGE MODELS

(71) Applicant: InLinks Optimization LTD, Biggleswade (GB)

(72) Inventor: Frederic Laurent, Carros (FR)

(21) Appl. No.: 19/275,624

(22) Filed: Jul. 21, 2025

Related U.S. Application Data
(60) Provisional application No. 63/762,371, filed on Feb. 24, 2025.

(51) Int. Cl. G06F 40/40; G06F 40/295; G06N 3/042; G06Q 30/0201

(52) U.S. Cl. CPC G06F 40/40; G06F 40/295; G06N 3/042; G06Q 30/02013

(57) ABSTRACT

The present disclosure provides a method of assessing a representation of a brand in language models. Further, the method may include generating one or more queries, obtaining one or more responses from one or more pre-trained language models based on the one or more queries, retrieving one or brand information associated with the one or more brands, and analyzing each of the one or more responses and the one or more brand information using one or more machine learning (ML) models configured for processing the one or more responses based on the one or more brand information and determining one or more values of one or more metrics based on the processing, generating a representation score for the representation of the one or more brands based on the one or more values of the one or more metrics, and transmitting the representation score to one or more brand devices.

### REFERENCE TO RELATED APPLICATIONS

This application claims the benefit of U.S. Provisional Patent Application No. 63/762,371, titled “SYSTEM AND METHOD FOR ASSESSING KNOWLEDGE REPRESENTATION OF BRANDS IN LARGE LANGUAGE MODELS”, filed Feb. 24, 2025, which is incorporated by reference herein in its entirety.

### FIELD OF DISCLOSURE

The present disclosure generally relates to the field of data processing. More specifically, the present disclosure relates to methods and systems of assessing a representation of a brand in language models.

### BACKGROUND

In an era where artificial intelligence (AI) has become integral to business operations, the accurate and consistent representation of brand knowledge has emerged as a critical factor in determining the effectiveness of AI-driven applications. Brands rely on AI systems to process and analyze information, from customer queries to product specifications, which necessitates that these systems possess a deep understanding of the brand's entities, relationships, and domain-specific knowledge. This understanding is essential for delivering accurate responses, maintaining consistency in branding, and ensuring compliance with brand guidelines.

Despite the growing reliance on AI, existing systems often struggle with several challenges. One major issue is the inconsistency in knowledge representation across different AI models and systems. Brands may find that their knowledge graphs contain discrepancies or omissions compared to what an LLM outputs, leading to misaligned or incomplete responses. Additionally, a lack of transparency in how AI systems process brand-related information can hinder trust and confidence among users, as they are often unaware of the reasoning behind model decisions.

Another significant problem is the inability of existing systems to dynamically adapt to evolving brand knowledge. As brands introduce new products, update marketing strategies, or receive feedback from customers, their knowledge bases grow and change. However, many AI systems fail to incorporate these updates effectively, leading to outdated or incomplete representations in LLM responses. This can result in poor user experiences and inaccuracies in AI-driven outputs.

Large language models (LLMs) have gained widespread use in generating human-like text based on training data. These models may include information about brands, companies, or entities derived from publicly available data sources. However, there is no existing system that allows brands to systematically assess or audit what these models “know” about them. The lack of transparency poses challenges for brand representation, accuracy, and trust.

Furthermore, the lack of robust monitoring and feedback mechanisms exacerbates these issues. Users often have limited tools to identify and address mismatches between brand knowledge and AI representations, leaving brands vulnerable to inconsistencies and misalignments that could affect their operations and reputation.

Given these challenges, methods, systems, or apparatuses capable of facilitating better alignment between brand knowledge and AI representations are required. These solutions should address the issues of inconsistency, misalignment, lack of transparency, and static knowledge bases to enhance the accuracy, reliability, and adaptability of AI-driven brand management tools. Therefore, there is a need for improved methods and systems of assessing a representation of a brand in language models.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of assessing a representation of a brand in language models. Further, the method may include generating, using a processing device, one or more queries associated with one or more brands. Further, the method may include obtaining, using the processing device, one or more responses from one or more pre-trained language models based on the one or more queries. Further, the method may include retrieving, using a storage device, one or more brand information associated with the one or more brands. Further, the method may include analyzing, using the processing device, each of the one or more responses and the one or more brand information using one or more machine learning (ML) models. Further, the one or more ML models may be configured for processing the one or more responses based on the one or more brand information. Further, the one or more ML models may be configured for determining one or more values of one or more metrics based on the processing. Further, the method may include generating, using the processing device, a representation score for the representation of the one or more brands based on the one or more values of the one or more metrics. Further, the method may include transmitting, using a communication device, the representation score to one or more brand devices associated with the one or more brands.

The present disclosure provides a system of assessing a representation of a brand in language models. Further, the system may include a processing device. Further, the processing device may be configured for generating one or more queries associated with one or more brands. Further, the processing device may be configured for obtaining one or more responses from one or more pre-trained language models based on the one or more queries. Further, the processing device may be configured for analyzing each of the one or more responses and one or more brand information using one or more machine learning (ML) models. Further, the one or more ML models may be configured for processing the one or more responses based on the one or more brand information. Further, the one or more ML models may be configured for determining one or more values of one or more metrics based on the processing. Further, the processing device may be configured for generating a representation score for the representation of the one or more brands based on the one or more values of the one or more metrics. Further, the system may include a storage device communicatively coupled with the processing device. Further, the storage device may be configured for retrieving the one or more brand information associated with the one or more brands. Further, the system may include a communication device communicatively coupled with the processing device. Further, the communication device may be configured for transmitting the representation score to one or more brand devices associated with the one or more brands.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of assessing a representation of a brand in language models, in accordance with some embodiments.

FIG. 4 illustrates a flowchart of a method 400 of assessing a representation of a brand in language models including analyzing, using the processing device 802, the at least one request, in accordance with some embodiments.

FIG. 5 illustrates a flowchart of a method 500 of assessing a representation of a brand in language models including analyzing, using the processing device 802, the at least one content using a second ML model, in accordance with some embodiments.

FIG. 6 illustrates a flowchart of a method 600 of assessing a representation of a brand in language models including receiving, using the communication, the at least one response from the at least one external computing device, in accordance with some embodiments.

FIG. 7 illustrates a flowchart of a method 700 of assessing a representation of a brand in language models including generating, using the processing device 802, at least one evaluation report, in accordance with some embodiments.

FIG. 8 illustrates a block diagram of a system 800 for assessing a representation of a brand in language models, in accordance with some embodiments.

FIG. 9A illustrates a flowchart of a method 900 of assessing a representation of a brand in language models including obtaining, using the processing device 802, at least one updated pre-trained language model, in accordance with some embodiments.

FIG. 9B illustrates a continuation of the flowchart of the method 900 of assessing a representation of a brand in language models including obtaining, using the processing device 802, at least one updated pre-trained language model, in accordance with some embodiments.

FIG. 10 illustrates a flowchart of a method 1000 for assessing knowledge representation of brands in large language models, in accordance with some embodiments.

FIG. 11A and FIG. 11B illustrate a flowchart of a method 1100 for assessing knowledge representation of brands in large language models including generating reports, in accordance with some embodiments.

FIG. 12 illustrates a block diagram of a system 1200 for assessing knowledge representation of brands in large language models, in accordance with some embodiments.

FIG. 13 illustrates a flowchart of a method 1300 for assessing knowledge representation of brands in large language models, in accordance with some embodiments.

FIG. 14 illustrates a flowchart of a method 1400 for assessing knowledge representation of brands in large language models including generating a query data, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes system and method for assessing knowledge representation of brands in large language models.

In some embodiments, the present disclosure relates to artificial intelligence and natural language processing, specifically to systems and methods for assessing and auditing the knowledge representation of a brand in large language models (LLMs) using knowledge graphs and entity analysis.

Further, Large language models (LLMs) have gained widespread use in generating human-like text based on training data. Further, these models may include information about brands, companies, or entities derived from publicly available data sources. However, there is no existing system that allows brands to systematically assess or audit what these models “know” about them. Further, the lack of transparency poses challenges for brand representation, accuracy, and trust.

Further, the disclosed system seeks to address this by providing a novel system that builds a knowledge graph of a brand and compares it to the knowledge inferred from querying LLMs. Further, the disclosed system allows brands to identify gaps, inaccuracies, and opportunities to manage their representation in AI systems.

In some embodiments, the present disclosure describes the following steps of the method for assessing and scoring the knowledge representation of brands in LLMs:
1. Gathering content from the brand's website or other authoritative sources.
2. Detecting named entities from the gathered content using natural language processing (NLP) techniques.
3. Building a knowledge graph that structures the relationships between the identified named entities.
4. Querying an LLM for information about the brand, based on the named entities in the knowledge graph.
5. Analyzing the LLM's responses to identify named entities and their relationships.
6. Comparing the entities and relationships in the LLM's response with the brand's knowledge graph.
7. Computing a knowledge representation score that quantifies the alignment or discrepancies between the two.

In some embodiments, the disclosed system comprises a processor, a memory module, and software instructions stored in the memory module, which are executed by the processor to perform the steps described herein. Further, the disclosed system includes the following components:

### 1. Web Content Scraper:

Gathers web pages and other digital content associated with the brand.
Extracts structured and unstructured data for analysis.

### 2. Named Entity Recognition (NER) Module:

Detects named entities from the scraped content using NLP models.
Identifies a relationship between entities.

### 3. Knowledge Graph Builder:

Constructs a graph representation of the brand's knowledge using detected entities and relationships.
Stores the graph in a structured database for querying.

### 4. LLM Query Engine:

Formulates brand related queries based on named entities in the knowledge graph.
Sends queries to the LLM to retrieve its knowledge representation.

### 5. Response Analyzer:

Analyzes LLM responses to extract named entities and relationships.
Compares the extracted entities with the brand's knowledge graph.

### 6. Scoring Engine:

Computes a knowledge representation score based on alignment metrics.
Metrics include entity overlap, relationship overlap, and accuracy of inferred data.

In some embodiments, the present disclosure describes the following methodology:

### 1. Gathering Brand Data:

The system scrapes the top-level pages of the brand's website, including text, metadata, and structured data (e.g., JSON-LD).
Other authoritative sources, such as social media profiles or press releases, may be included.

### 2. Detecting Named Entities:

The system uses NLP techniques such as pre-trained NER models to identify named entities (e.g., product names, locations, executives).
Relationships between entities (e.g., “CEO of,” “located in”) are also identified.

### 3. Building the Knowledge Graph:

Entities and relationships are stored as nodes and edges in a knowledge graph.
The graph is structured to reflect the brand's core knowledge domains.

### 4. Querying the LLM:

For each named entity or relationship in the graph, the system formulates specific queries (e.g., “What do you know about this [brand] and its relationship with [entity]?”).
The LLM's response is retrieved and stored for analysis.

### 5. Analyzing LLM Responses:

Named entities and relationships in the LLM's response are extracted using the NER module.
These entities are compared against the brand's knowledge graph to identify similarities and differences.

### 6. Scoring Knowledge Representation:

The scoring engine computes metrics such as:
   a) Entity Precision: Percentage of LLM-identified entities that match the graph.
   b) Entity Recall: Percentage of graph entities identified by the LLM.
   c) Relationship Accuracy: Alignment of relationships in the LLM response with the graph.
A final knowledge representation score is calculated to provide a comprehensive measure of alignment.

In some embodiments, the present disclosure describes the following applications of the disclosed system:
Monitoring brand representation in LLMs.
Identifying gaps and inaccuracies in LLM knowledge.
Providing actionable insights to improve brand presence in AI systems.

In some embodiments, the present disclosure describes a system for assessing knowledge representation of a brand in large language models, including:
A web content scraper to gather brand data from online sources.
A named entity recognition module to detect entities and relationships from the brand data.
A knowledge graph builder to structure the detected entities and relationships into a knowledge graph.
A query engine to formulate and send queries to a large language model based on entities in the knowledge graph.
A response analyzer to extract named entities and relationships from the LLM responses.
A scoring engine to compute a knowledge representation score by comparing the entities and relationships from the LLM responses to the knowledge graph.

Further, the named entity recognition module uses a pre-trained machine learning model to detect entities and relationships.

Further, the scoring engine computes entity precision, recall, and relationship accuracy as part of the knowledge representation score.

In some embodiments, the present disclosure describes a method for assessing knowledge representation of a brand in large language models, including the steps of:
Gathering brand data from online sources.
Detecting named entities and relationships in the gathered data.
Building a knowledge graph to structure the detected entities and relationships.
Querying a large language model for information about the brand.
Analyzing responses from the large language model to extract named entities and relationships.
Comparing the extracted entities and relationships to the knowledge graph.
Computing a knowledge representation score based on the comparison.

Further, the disclosed method may include generating reports that highlight discrepancies and opportunities to improve brand representation in large language models.

In some embodiments, the present disclosure describes system and method for assessing and scoring the knowledge representation of brands in large language models (LLMs) using knowledge graphs and entity analysis. Further, the disclosed system gathers brand data, detects named entities, constructs a knowledge graph, queries LLMs, analyzes their responses, and computes a knowledge representation score. Further, the disclosed system enables brands to monitor, audit, and improve their representation in AI systems.

In some embodiments, the present disclosure describes a system for enabling knowledge alignment scoring, which involves comparing the knowledge representation of a brand as structured in a knowledge graph against responses from large language models (LLMs). Further, the system is designed to quantify how well an LLM understands and represents the brand's entities, relationships, and domain-specific knowledge.

In some embodiments, the system may incorporate explainability techniques to provide insights into how the LLM processes brand-related information. Further, incorporation of explainability techniques ensures that users can understand the reasoning behind the model's responses, thereby enhancing transparency and trust in the system. Further, the integration involves adding modules that trace the flow of data through the LLM and correlate it with the knowledge graph. For example, the system may use techniques like attention mechanisms or saliency maps to highlight key parts of the input that influenced the output. Further, the incorporation improves the interpretability of LLM outputs, addressing a significant gap in current AI systems by making decision-making processes more comprehensible.

In some embodiments, the system may leverage active learning strategies to continuously refine its knowledge alignment scoring based on user feedback and new data. Further, these strategies allow the system to adapt to evolving brand information and user expectations over time. For instance, the system might prioritize updates for entities or relationships that frequently result in mismatches between the knowledge graph and LLM responses. Further, by iteratively improving its understanding of brand knowledge, the system reduces alignment errors and enhances accuracy over successive queries. Further, this dynamic adaptation is particularly useful for brands with rapidly changing products or services, where timely and accurate knowledge representation is critical.

In some embodiments, the system may include robust privacy-preserving mechanisms to ensure compliance with data protection regulations such as GDPR (General Data Protection Regulation). Further, these features allow the system to handle sensitive brand information securely while still performing knowledge alignment scoring. For example, the system may use secure multi-party computation or homomorphic encryption to process and analyze data without exposing raw information to potential breaches. Further, this implementation improves the system's ability to work with confidential data, addressing a growing concern in AI-driven applications where data privacy is paramount.

In some embodiments, the system may be equipped with real-time monitoring capabilities that provide continuous updates on the alignment between the knowledge graph and LLM responses. Further, the real-time monitoring capabilities allows users to track changes in brand representation over time, identifying potential shifts or degradations in knowledge accuracy. For example, the system might send alerts when a critical entity or relationship deviates from its expected alignment. Further, real-time monitoring enhances the system's utility by providing actionable insights that enable proactive adjustments to brand knowledge management.

In some embodiments, the system may include interactive debugging tools that allow users to inspect and modify the knowledge graph. Further, these tools facilitate a more hands-on approach to refining brand representation, enabling users to correct inaccuracies or update outdated information directly within the system. For instance, users can highlight mismatches between LLM responses and the knowledge graph, then use debugging tools to adjust entities or relationships as needed. Further, these tools feature improves the flexibility and adaptability of the system, empowering users to tailor brand knowledge representation to their specific needs.

In some embodiments, the system may integrate multimodal AI techniques that combine textual, visual, and other forms of data to improve knowledge alignment scoring. Further, by incorporating multimodal models, the system can leverage additional information sources beyond text, such as images or videos, to enhance its understanding of brand entities and relationships. For example, the system might use visual recognition to identify brand elements in product images, thereby supplementing textual data with valuable context. Further, the implementation improves the system's ability to capture a broader range of brand knowledge, leading to more accurate comparisons with LLM responses.

In some embodiments, the system may incorporate contextual reasoning modules that consider the broader context of brand information when comparing it to LLM outputs. Further, these modules analyze how different aspects of brand knowledge interrelate and influence each other, providing a more holistic understanding of brand representation. For example, the system might assess how a brand's product features relate to its marketing strategies or customer feedback. Further, contextual reasoning enhances the depth of knowledge alignment scoring, enabling the system to uncover complex relationships that might otherwise be overlooked.

In some embodiments, the system may feature a feedback loop that incorporates user input and model performance data into ongoing improvements. Further, this mechanism allows for iterative enhancements to the knowledge graph and LLM querying strategies over time. For example, users can provide specific feedback on discrepancies between LLM responses and brand knowledge, which is then analyzed alongside performance metrics to guide future updates. Further, a version control system tracks these iterations, ensuring that each improvement is documented and tested before implementation. Further, the feedback loop improves the system's robustness and adaptability, making it more reliable for long-term use.

In some embodiments, the system includes at least one machine learning (ML) model that processes data relating to a brand, such as text, images, audio, or video. The ML model may include neural network layers, pre-trained model weights, transfer learning routines, or fine-tuning pipelines. The ML model is implemented as software instructions stored in a non-transitory computer-readable storage medium and executed by at least one processor (i.e., processing device).

The ML model may be structured as a deep neural network with multiple layers, such as an encoder layer, a decoder layer, a fully connected layer, or an attention layer. For training or fine-tuning, the system uses backpropagation with gradient descent or stochastic optimizers (e.g., SGD, Adam, RMSProp). Training data may include brand-specific labeled text, customer reviews, user queries, or other relevant examples that enable supervised or semi-supervised learning. The ML model may output numeric values, classifications, or probabilities used to compute one or more performance metrics or scores.

In some embodiments, the system leverages and/or includes a large language model (LLM) that is pre-trained on general-purpose language data. Examples of LLM architectures include transformer-based models such as GPT, BERT, RoBERTa, T5, or similar. The LLM comprises a tokenization module, an embedding layer, multi-head self-attention layers, feedforward layers, and output layers. For context-specific adaptation, the LLM may be fine-tuned using brand-related corpora to capture nuances in brand tone, messaging, or representation. Fine-tuning is performed on the same processing device or on distributed hardware (e.g., cloud instances).

The LLM is executed by the processing device to generate text-based responses, parse user queries, or analyze brand mentions. Generated responses are compared with stored brand information to compute representation scores and relevant metrics. Tokenization may use standard algorithms such as WordPiece, SentencePiece, or Byte Pair Encoding (BPE).

The system may also include NLP models for specific tasks, such as sentiment analysis, entity recognition, language detection, or similarity scoring. For sentiment, a classifier (e.g., fine-tuned BERT) predicts a sentiment polarity score, which may adjust a base metric. For entity recognition, the system may use a named entity recognition (NER) layer that extracts key brand terms or competitor mentions.

In multi-language embodiments, a language detection module determines the language of the response text. A language-specific tokenizer and encoder may then be selected dynamically. This enables the system to adaptively handle multilingual brand data and maintain consistent metric generation across languages.

If multiple data types are involved (text, images, video, audio), the system processes each modality using an appropriate encoder. For text, the system uses a transformer encoder; for images, a convolutional neural network (CNN) or vision transformer; for audio, spectrograms or Mel Frequency Cepstral Coefficients (MFCC) may be extracted. The system fuses embeddings using an attention-based fusion layer or concatenation layer. This multi-modal representation is input to a downstream classifier or regressor to produce brand representation scores.

Training data, responses, and brand information may be stored in encrypted form using AES-256 or equivalent cryptography standards. Keys may be stored in hardware security modules (HSMs) comprised in the system. Decryption occurs in secure memory, and transient data is purged from memory once processing is complete.

All model operations, including training, inference, encryption, decryption, and dashboard rendering, are performed by at least one processor (i.e., processing device). Storage of model weights, input data, and output metrics occurs on non-transitory storage media, such as hard drives, SSDs, or cloud storage buckets. Real-time operations may be implemented with streaming pipelines using message brokers or event-driven frameworks.

Final metric values and representation scores are made available via an interactive dashboard. The dashboard may be served as a web interface using standard web frameworks such as React, Angular, or Vue, with data visualizations rendered using charting libraries (e.g., D3.js, Chart.js). Metric values are provided through secure APIs and may be downloaded or exported in standard formats (e.g., JSON, CSV).

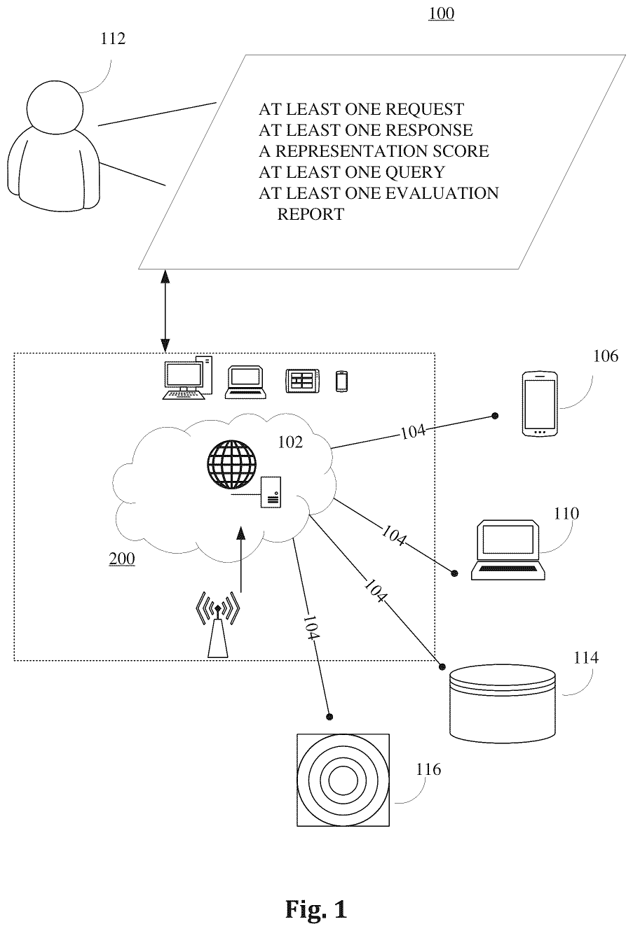

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

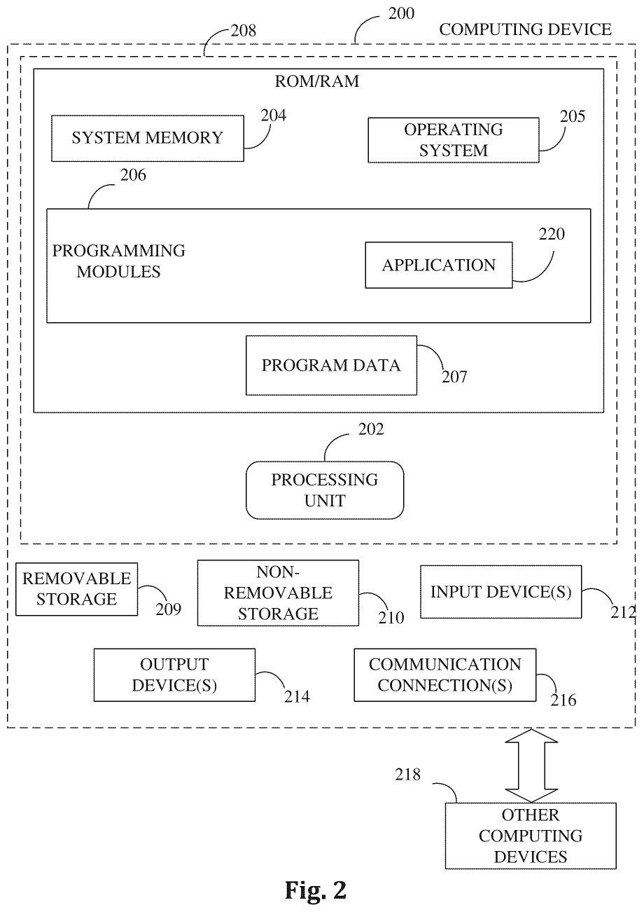

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

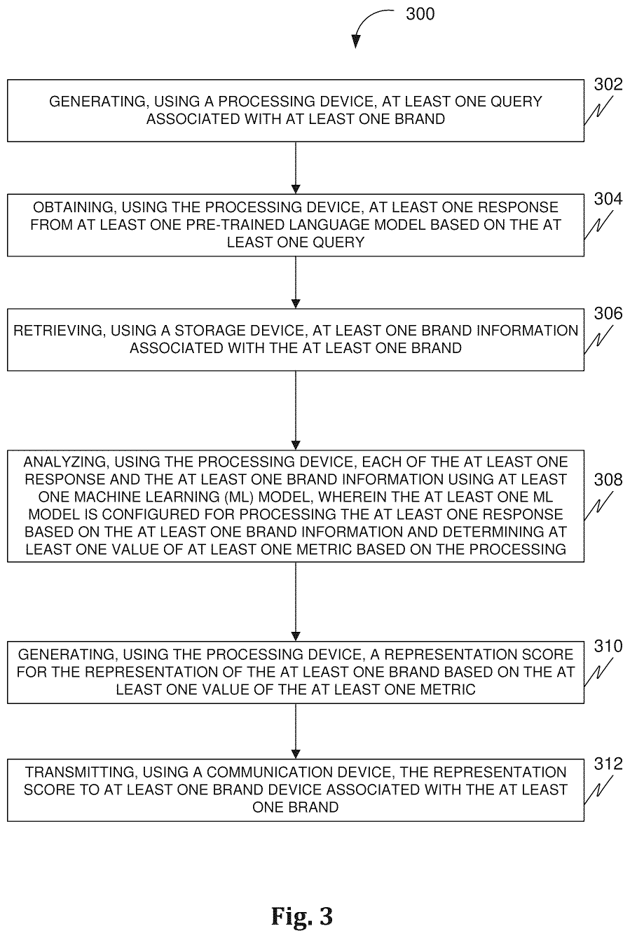

FIG. 3 illustrates a flowchart of a method 300 of assessing a representation of a brand in language models, in accordance with some embodiments.

Accordingly, the method 300 may include a step 302 of generating, using a processing device 802, one or more queries associated with one or more brands. Further, the method 300 may include a step 304 of obtaining, using the processing device 802, one or more responses from one or more pre-trained language models based on the one or more queries. Further, the method 300 may include a step 306 of retrieving, using a storage device 804, one or more brand information associated with the one or more brands. Further, the method 300 may include a step 308 of analyzing, using the processing device 802, each of the one or more responses and the one or more brand information using one or more machine learning (ML) models. Further, the one or more ML models may be configured for processing the one or more responses based on the one or more brand information. Further, the one or more ML models may be configured for determining one or more values of one or more metrics based on the processing. Further, the method 300 may include a step 310 of generating, using the processing device 802, a representation score for the representation of the one or more brands based on the one or more values of the one or more metrics. Further, the method 300 may include a step 312 of transmitting, using a communication device 806, the representation score to one or more brand devices 808 associated with the one or more brands.

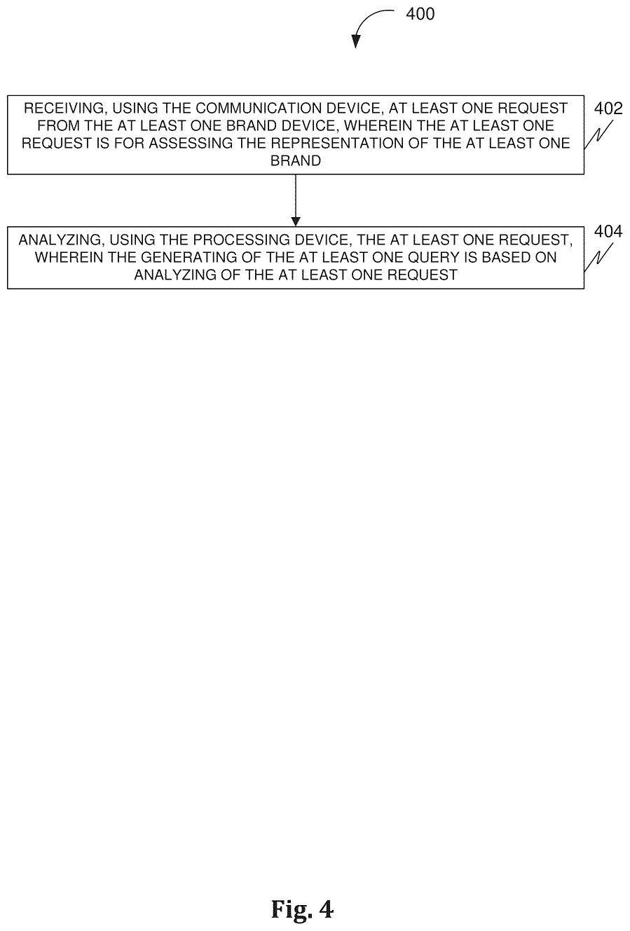

FIG. 4 illustrates a flowchart of a method 400 of assessing a representation of a brand in language models including analyzing, using the processing device 802, the at least one request, in accordance with some embodiments.

Further, in some embodiments, the method 400 further may include a step 402 of receiving, using the communication device 806, one or more requests from the one or more brand devices 808. Further, the one or more requests may be for assessing the representation of the one or more brands. Further, in some embodiments, the method 400 further may include a step 404 of analyzing, using the processing device 802, the one or more requests. Further, the generating of the one or more queries may be based on analyzing of the one or more requests.

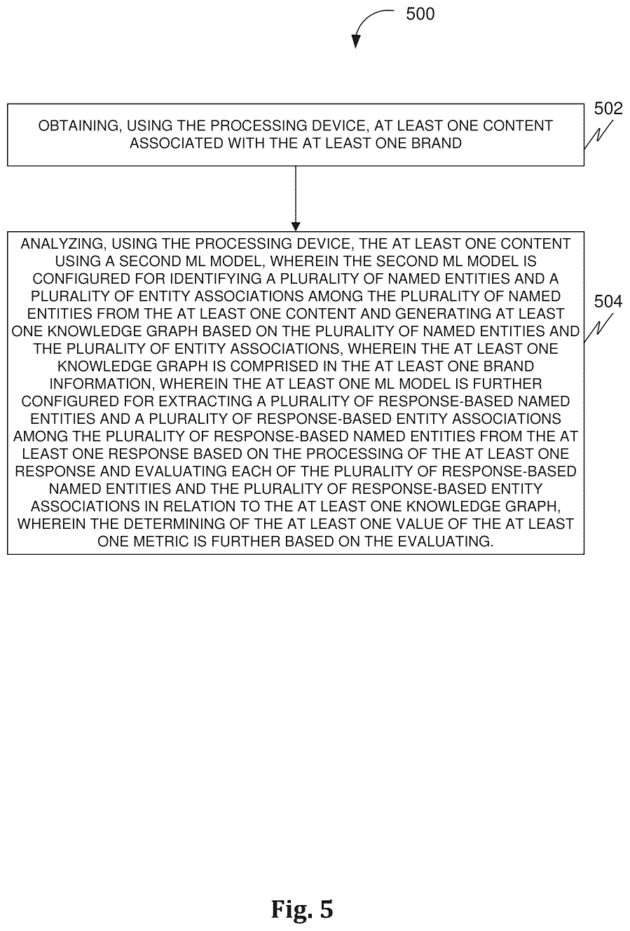

FIG. 5 illustrates a flowchart of a method 500 of assessing a representation of a brand in language models including analyzing, using the processing device 802, the at least one content using a second ML model, in accordance with some embodiments.

Further, in some embodiments, the method 500 further may include a step 502 of obtaining, using the processing device 802, one or more contents associated with the one or more brands. Further, in some embodiments, the method 500 further may include analyzing, using the processing device 802. Further, the one or more contents using a second ML model. Further, the second ML model may be configured for identifying two or more named entities and two or more entity associations among the two or more named entities from the one or more contents. Further, the second ML model may be configured for generating one or more knowledge graphs based on the two or more named entities and the two or more entity associations. Further, the one or more knowledge graphs may be comprised in the one or more brand information. Further, the one or more ML models may be further configured for extracting two or more response-based named entities and two or more response-based entity associations among the two or more response-based named entities from the one or more responses based on the processing of the one or more responses. Further, the one or more ML models may be further configured for evaluating each of the two or more response-based named entities and the two or more response-based entity associations in relation to the one or more knowledge graphs. Further, the determining of the one or more values of the one or more metrics may be further based on the evaluating.

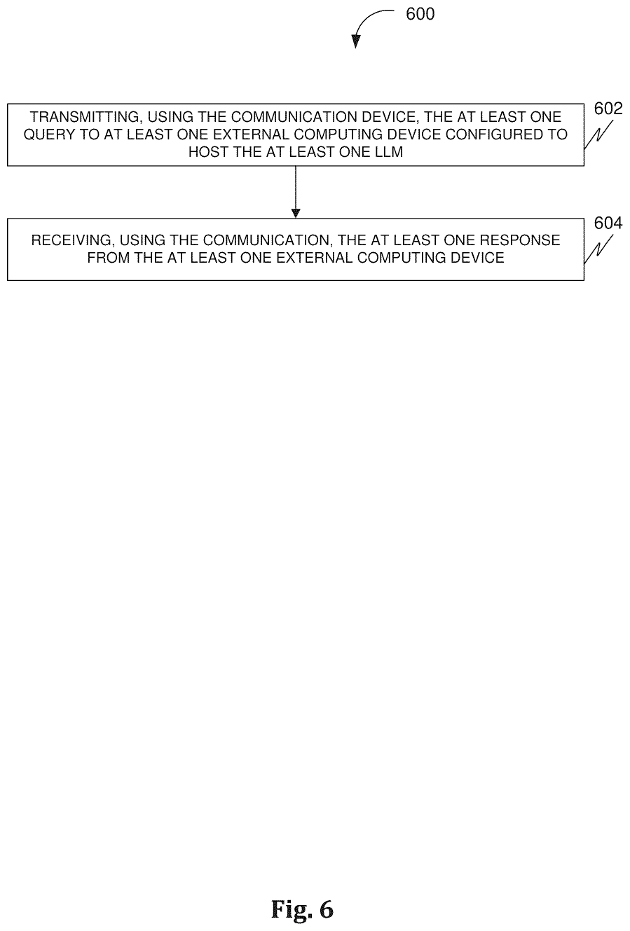

FIG. 6 illustrates a flowchart of a method 600 of assessing a representation of a brand in language models including receiving, using the communication, the at least one response from the at least one external computing device, in accordance with some embodiments.

Further, in some embodiments, the one or more pre-trained language models may include one or more large language models (LLMs). Further, the method 600 further may include a step 602 of transmitting, using the communication device 806, the one or more queries to one or more external computing devices which may be configured to host the one or more LLMS. Further, the method 600 further may include a step 604 of receiving, using the communication, the one or more responses from the one or more external computing devices.

In some embodiments, the evaluating of each of the two or more response-based named entities and the two or more response-based entity associations in relation to the one or more knowledge graphs includes evaluating each of the two or more response-based named entities and the two or more response-based entity associations in relation to the one or more knowledge graphs using one or more scoring engine modules.

In some embodiments, the one or more metrics includes one or more of an entity overlap, a relationship overlap, and an inference accuracy associated with each of the two or more response-based named entities and the two or more response-based entity associations in relation to the one or more knowledge graphs. Further, the entity overlap represents an equivalence associated with the two or more named entities and the two or more response-based named entities. Further, the relationship overlap represents the equivalence associated with the two or more entity associations and the two or more response-based entity associations.

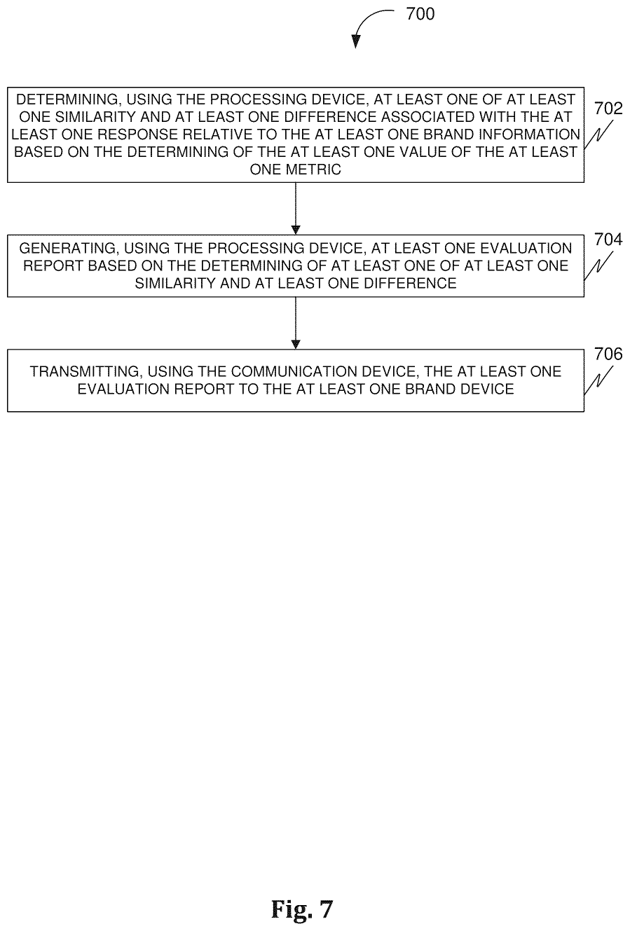

FIG. 7 illustrates a flowchart of a method 700 of assessing a representation of a brand in language models including generating, using the processing device 802, at least one evaluation report, in accordance with some embodiments.

Further, in some embodiments, the method 700 further may include a step 702 of determining, using the processing device 802, one or more of one or more similarities and one or more differences associated with the one or more response in relation to the one or more brand information based on the determining of the one or more values of the one or more metrics. Further, in some embodiments, the method 700 further may include a step 704 of generating, using the processing device 802, one or more evaluation reports based on the determining of one or more of one or more similarities and one or more differences. Further, in some embodiments, the method 700 further may include a step 706 of transmitting, using the communication device 806, the one or more evaluation reports to the one or more brand devices 808.

In some embodiments, the two or more named entities may be represented as two or more nodes in the one or more knowledge graphs. Further, the two or more entity associations may be represented as two or more edges in the one or more knowledge graphs. Further, each of the two or more edges connect a pair of nodes from the two or more nodes to represent a semantic relationship among the pair of nodes.

In some embodiments, the generating of the one or more knowledge graphs based on the two or more named entities and the two or more entity associations includes generating the one or more knowledge graphs based on the two or more named entities and the two or more entity associations using one or more knowledge graph builder modules.

In some embodiments, the method 500 may further include analyzing, using the processing device 802, the one or more responses using one or more response analyzer modules. Further, the extracting of the two or more response-based named entities and the two or more response-based entity associations by the one or more ML models may be based on the analyzing of the one or more responses using the response analyzer module.

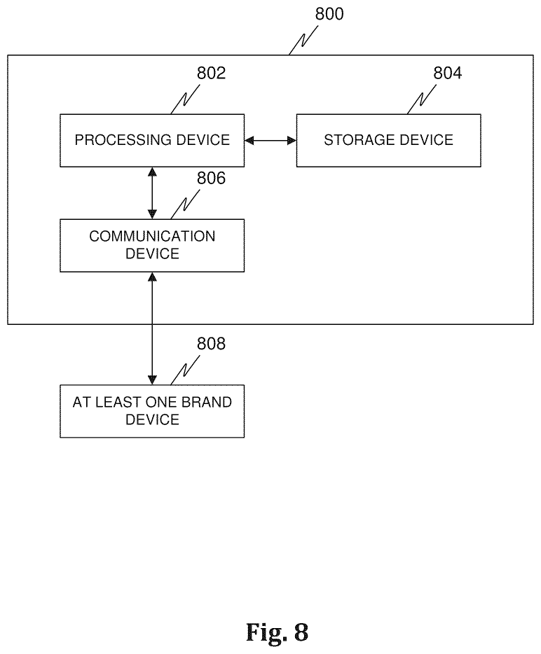

FIG. 8 illustrates a block diagram of a system 800 of assessing a representation of a brand in language models, in accordance with some embodiments.

Accordingly, the system 800 may include a processing device 802. Further, the processing device 802 may be configured for generating one or more queries associated with one or more brands. Further, the processing device 802 may be configured for obtaining one or more responses from one or more pre-trained language models based on the one or more queries. Further, the processing device 802 may be configured for analyzing each of the one or more responses and one or more brand information using one or more machine learning (ML) models. Further, the one or more ML models may be configured for processing the one or more responses based on the one or more brand information. Further, the one or more ML models may be configured for determining one or more values of one or more metrics based on the processing. Further, the processing device 802 may be configured for generating a representation score for the representation of the one or more brands based on the one or more values of the one or more metrics. Further, the system 800 may include a storage device 804 communicatively coupled with the processing device 802. Further, the storage device 804 may be configured for retrieving the one or more brand information associated with the one or more brands. Further, the system 800 may include a communication device 806 communicatively coupled with the processing device 802. Further, the communication device 806 may be configured for transmitting the representation score to one or more brand devices 808 associated with the one or more brands.

In some embodiments, the communication device 806 may be further configured for receiving one or more requests from the one or more brand devices 808. Further, the one or more requests may be for assessing the representation of the one or more brands. Further, the processing device 802 may be further configured for analyzing the one or more requests. Further, the generating of the one or more queries may be based on analyzing of the one or more requests.

Further, in some embodiments, the processing device 802 may be further configured for obtaining one or more contents associated with the one or more brands. Further, the processing device 802 may be further configured for analyzing the one or more contents using a second ML model. Further, the second ML model may be configured for identifying two or more named entities and two or more entity associations among the two or more named entities from the one or more contents. Further, the second ML model may be configured for generating one or more knowledge graphs based on the two or more named entities and the two or more entity associations. Further, the one or more knowledge graphs may be comprised in the one or more brand information. Further, the one or more ML models may be further configured for extracting two or more response-based named entities and two or more response-based entity associations among the two or more response-based named entities from the one or more responses based on the processing of the one or more responses. Further, the one or more ML models may be further configured for evaluating each of the two or more response-based named entities and the two or more response-based entity associations in relation to the one or more knowledge graphs. Further, the determining of the one or more values of the one or more metrics may be further based on the evaluating.

Further, in some embodiments, the one or more pre-trained language models may include one or more large language models (LLMs). Further, the communication device 806 may be further configured for transmitting the one or more queries to one or more external computing devices which may be configured to host the one or more LLMs. Further, the communication device 806 may be further configured for receiving the one or more responses from the one or more external computing devices.

In some embodiments, the evaluating of each of the two or more response-based named entities and the two or more response-based entity associations in relation to the one or more knowledge graphs includes evaluating each of the two or more response-based named entities and the two or more response-based entity associations in relation to the one or more knowledge graphs using one or more scoring engine modules.

In some embodiments, the one or more metrics includes one or more of an entity overlap, a relationship overlap, and an inference accuracy associated with each of the two or more response-based named entities and the two or more response-based entity associations in relation to the one or more knowledge graphs. Further, the entity overlap represents an equivalence associated with the two or more named entities and the two or more response-based named entities. Further, the relationship overlap represents the equivalence associated with the two or more entity associations and the two or more response-based entity associations.

Further, in some embodiments, the processing device 802 may be further configured for determining one or more of one or more similarities and one or more differences associated with the one or more response in relation to the one or more brand information based on the determining of the one or more values of the one or more metrics. Further, the processing device 802 may be further configured for generating one or more evaluation reports based on the determining of one or more of one or more similarities and one or more differences. Further, the communication device 806 may be further configured for transmitting the one or more evaluation reports to the one or more brand devices 808.

In some embodiments, the two or more named entities may be represented as two or more nodes in the one or more knowledge graphs. Further, the two or more entity associations may be represented as two or more edges in the one or more knowledge graphs. Further, each of the two or more edges connect a pair of nodes from the two or more nodes to represent a semantic relationship among the pair of nodes.

In some embodiments, the generating of the one or more knowledge graphs based on the two or more named entities and the two or more entity associations includes generating the one or more knowledge graphs based on the two or more named entities and the two or more entity associations using one or more knowledge graph builder modules.

In some embodiments, the processing device 802 may be further configured for analyzing the one or more responses using one or more response analyzer modules. Further, the extracting of the two or more response-based named entities and the two or more response-based entity associations by the one or more ML models may be based on the analyzing of the one or more responses using the response analyzer module.

In some embodiments, the generating of the one or more queries associated with the one or more brands includes generating the one or more queries associated with the one or more brands using one or more query-generator modules.

In some embodiments, the obtaining of the one or more contents associated with the one or more brands includes obtaining the one or more contents associated with the one or more brands using one or more web-content scraper modules.

In some embodiments, the one or more ML models includes one or more natural language processing (NLP) models. Further, the one or more NLP models includes one or more named entity recognition (NER) modules.

In some embodiments, the one or more contents includes one or more of one or more web page contents and one or more publically-available digital contents of the one or more brands.

In some embodiments, the method 500 may further include storing, using the storage device 804, the one or more knowledge graphs.

In some embodiments, the one or more contents further includes one or more of one or more social media profile information and one or more press-release information of the one or more brands.

In some embodiments, the two or more named entities includes one or more of one or more product names, one or more locations, and one or more executives associated with the one or more brands.

In some embodiments, the one or more evaluation reports includes one or more of an inaccuracy and a knowledge gap in the representation of the one or more brands in the one or more pre-trained language models.

In some embodiments, the one or more evaluation reports further includes an improvement opportunity associated with the one or more brands for improving the representation of the one or more brands in the one or more pre-trained language models.

In some embodiments, the one or more web page contents includes one or more of a textual content, a metadata associated with one or more web pages, and one or more structured data associated with the one or more brands.

Further, in some embodiments, the one or more ML models may be further configured for generating one or more first feature vectors based on the one or more responses based on the processing of the one or more responses. Further, the one or more ML models may be further configured for comparing the one or more first feature vectors to two or more second feature vectors. Further, the two or more second feature vectors corresponds to two or more pieces of augmentation information associated with the one or more brands. Further, the one or more ML models may be further configured for identifying one or more second feature vectors from the two or more second feature vectors that satisfy one or more pre-determined conditions with respect to the one or more first feature vectors. Further, the determining of the one or more values of one or more metrics may be further based on the identifying of the one or more second feature vectors from the two or more second feature vectors.

In some embodiments, the comparing of the one or more first feature vectors to the two or more second feature vectors include determining two or more cosine similarities between the one or more first feature vectors and the two or more second feature vectors.

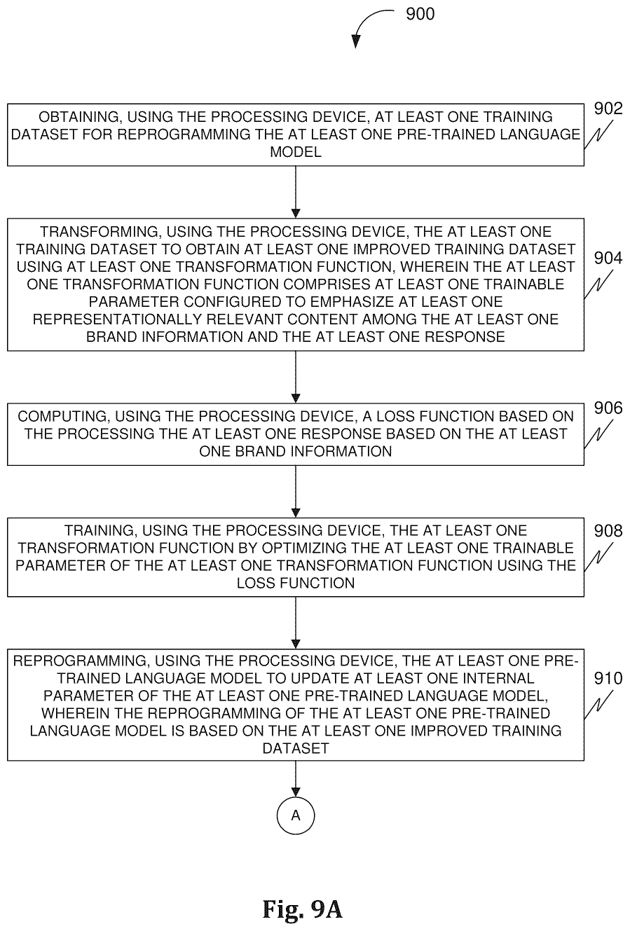

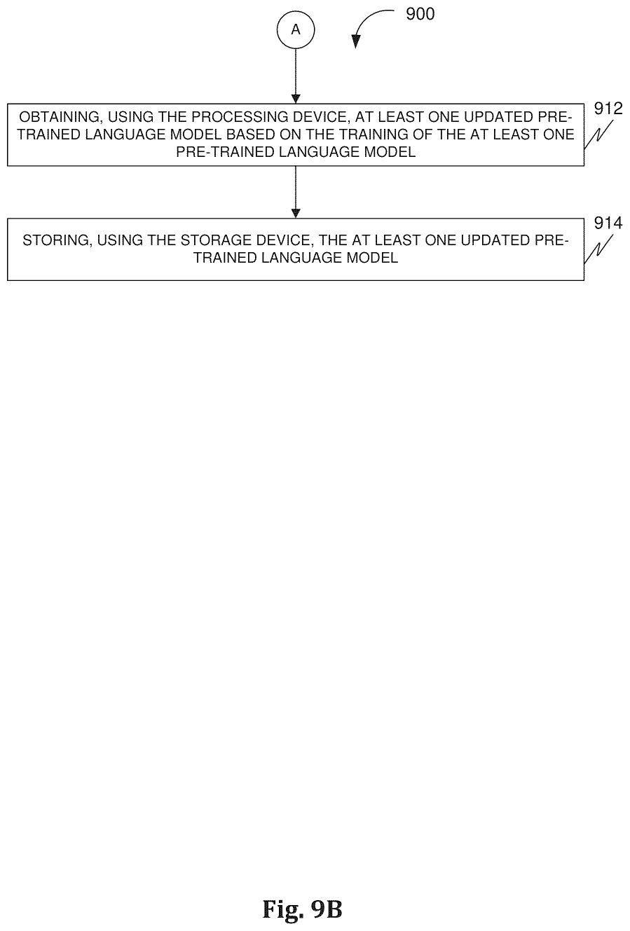

FIG. 9A and FIG. 9B illustrate a flowchart of a method 900 of assessing a representation of a brand in language models including obtaining, using the processing device 802, at least one updated pre-trained language model, in accordance with some embodiments.

Further, in some embodiments, the method 900 further may include a step 902 of obtaining, using the processing device 802, one or more training datasets for reprogramming the one or more pre-trained language models. Further, in some embodiments, the method 900 further may include a step 904 of transforming, using the processing device 802, the one or more training datasets to obtain one or more improved training datasets using one or more transformation functions. Further, the one or more transformation functions includes one or more trainable parameters which may be configured to emphasize at least one representationally relevant content among the one or more brand information and the one or more responses. Further, in some embodiments, the method 900 further may include a step 906 of computing, using the processing device 802, a loss function based on the processing the one or more responses based on the one or more brand information. Further, in some embodiments, the method 900 further may include a step 908 of training, using the processing device 802, the one or more transformation functions by optimizing the one or more trainable parameters of the one or more transformation functions using the loss function. Further, in some embodiments, the method 900 further may include a step 910 of reprogramming, using the processing device 802, the one or more pre-trained language models to update one or more internal parameters of the one or more pre-trained language models. Further, the reprogramming of the one or more pre-trained language models may be based on the one or more improved training datasets. Further, in some embodiments, the method 900 further may include a step 912 of obtaining, using the processing device 802, one or more updated pre-trained language models based on the training of the one or more pre-trained language models. Further, in some embodiments, the method 900 further may include a step 914 of storing, using the storage device 804, the one or more updated pre-trained language models.

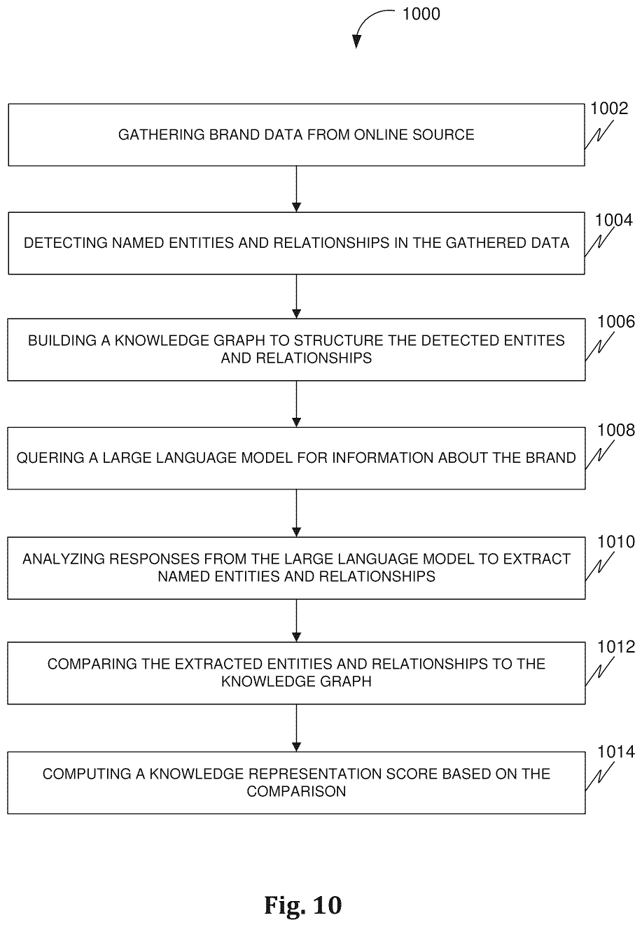

FIG. 10 illustrates a flowchart of a method 1000 for assessing knowledge representation of brands in large language models, in accordance with some embodiments.

Accordingly, the method 1000 may include a step 1002 of gathering brand data from online source. Further, the method 1000 may include a step 1004 of detecting named entities and relationships in the gathered data. Further, the method 1000 may include a step 1006 of building a knowledge graph to structure the detected entities and relationships. Further, the method 1000 may include a step 1008 of querying a large language model for information about the brand. Further, the method 1000 may include a step 1010 of analyzing responses from the large language model to extract named entities and relationships. Further, the method 1000 may include a step 1012 of comparing the extracted entities and relationships to the knowledge graph. Further, the method 1000 may include a step 1014 of computing a knowledge representation score based on the comparison.

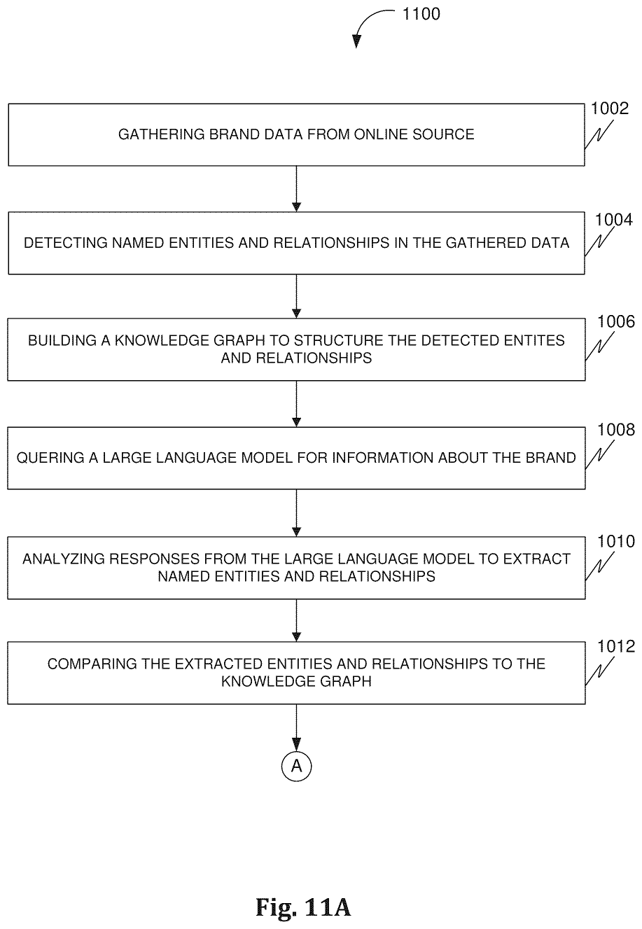

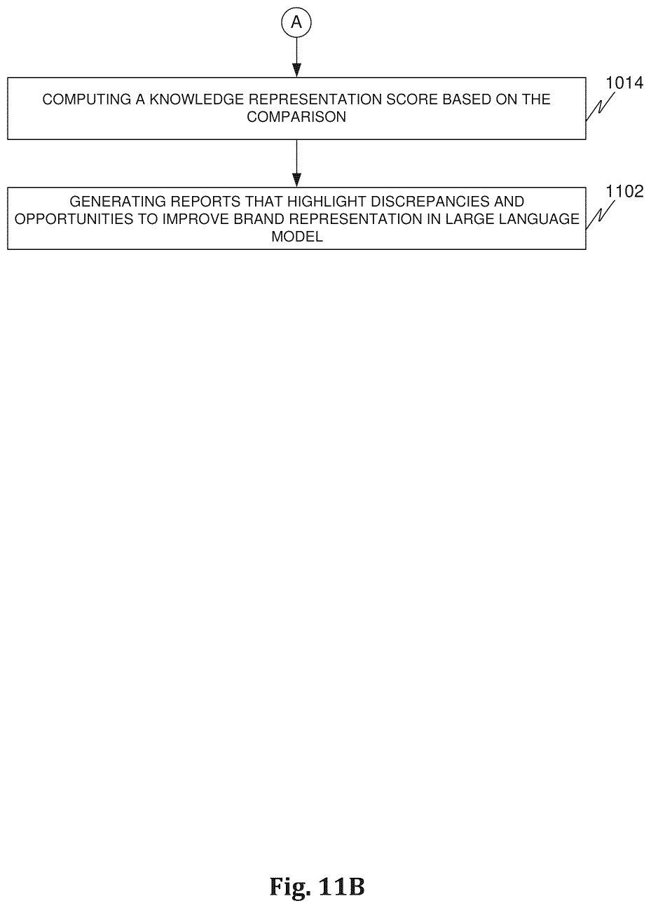

FIG. 11A and FIG. 11B illustrates a flowchart of a method 1100 for assessing knowledge representation of brands in large language models including generating reports, in accordance with some embodiments.

Further in some embodiments, the method 1100 may include the step 1002 of gathering brand data from online source. Further, the method 1100 may include the step 1004 of detecting named entities and relationships in the gathered data. Further, the method 1100 may include the step 1006 of building a knowledge graph to structure the detected entities and relationships. Further, the method 1100 may include the step 1008 of querying a large language model for information about the brand. Further, the method 1100 may include the step 1010 of analyzing responses from the large language model to extract named entities and relationships. Further, the method 1100 may include the step 1012 of comparing the extracted entities and relationships to the knowledge graph. Further, the method 1100 may include the step 1014 of computing a knowledge representation score based on the comparison. Further, the method 1100 may include a step 1102 of generating reports that highlight discrepancies and opportunities to improve brand representation in large language model.

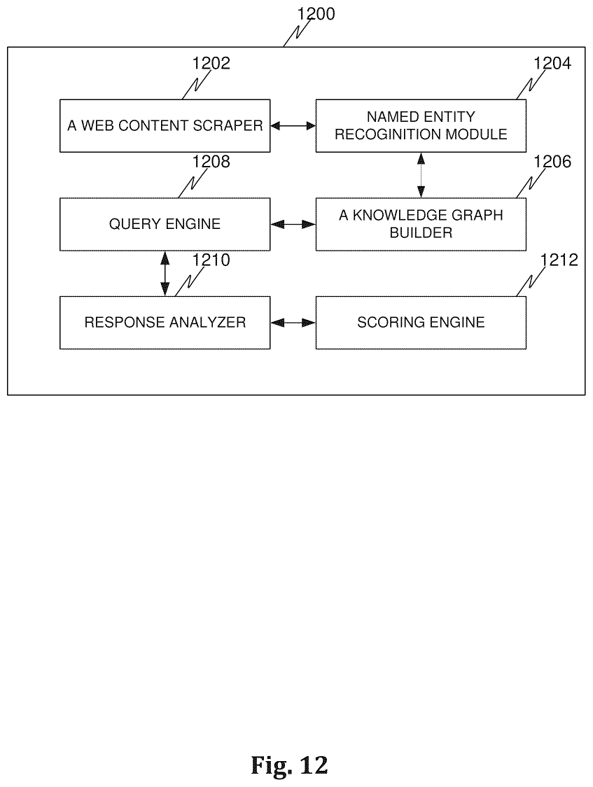

FIG. 12 illustrates a block diagram of a system 1200 for assessing knowledge representation of brands in large language models, in accordance with some embodiments.

Accordingly, the system 1200 may include a web content scraper 1202. Further, the web content scraper 1202 may be configured to gather brand data from online sources. Further, the system 1200 may include a name entity recognition module 1204. Further, the named entity recognition module 1204 may be configured to detect entities and relationships from the brand data. Further, the system may include a knowledge graph builder 1206. Further, the knowledge graph builder 1206 is configured to structure the detected entities and relationships into a knowledge graph. Further, the system may include a query engine 1208. Further, the query engine 1208 is configured to formulate and send queries to a large language model based on entities in the knowledge graph. Further, the system may include a response analyzer 1210. Further, the response analyzer 1210 may be configured to extract named entities and relationship from the LLM responses. Further, the system may include a scoring engine 1212. Further, the scoring engine 1212 may be configured to compute a knowledge representation score by comparing the entities and relationship from the LLM response to the knowledge graph.

In some embodiments, the named entity recognition module 1204 uses a pre-trained machine learning model to detect entities and relationships.

In some embodiments, the scoring engine 1212 computes entity precision, recall, and relationship accuracy as part of the knowledge representation score

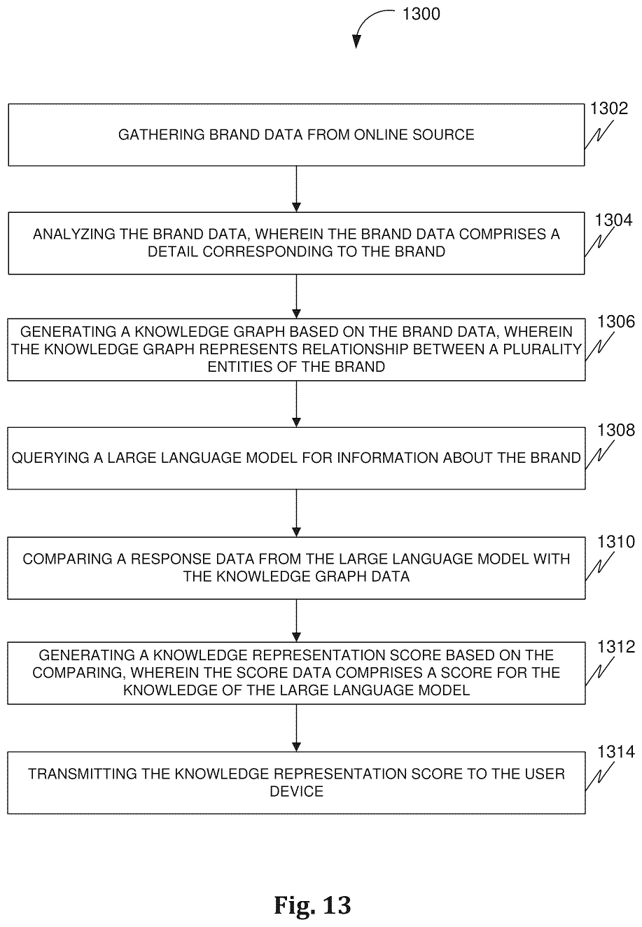

FIG. 13 illustrates a flowchart of a method 1300 for assessing knowledge representation of brands in large language models, in accordance with some embodiments.

Accordingly, the method 1300 may include a step 1302 of gathering brand data from online source. Further, the method 1300 may include a step of analyzing the brand data, wherein the brand data comprises a detail corresponding to the brand. Further, the method 1300 may include a step 1306 of generating a knowledge graph based on the brand data, wherein the knowledge graph represents relationship between a plurality entities of the brand. Further, the method 1300 may include a step 1308 of querying a large language model for information about the brand. Further, the method 1300 may include a step 1310 of comparing a response data from the large language model with the knowledge graph data. Further, the method 1300 may include a step 1312 of generating a knowledge representation score based on the comparing, wherein the score data comprises a score for the knowledge of the large language model. Further, the method 1300 may include a step 1314 of transmitting the knowledge score to the user device.

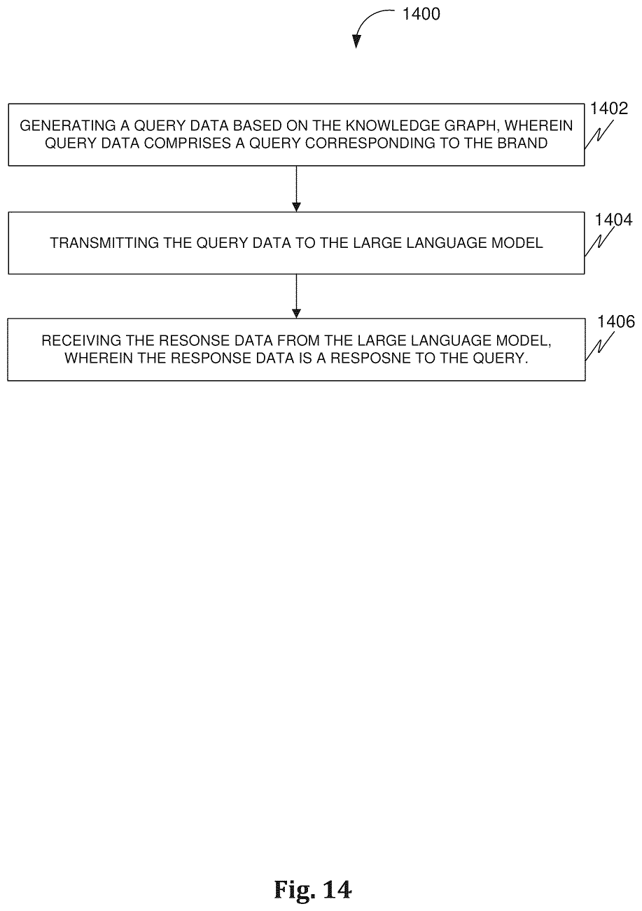

FIG. 14 illustrates a flowchart of a method 1400 for assessing knowledge representation of brands in large language models including generating a query data, in accordance with some embodiments.

Accordingly, the method 1400 may include a step 1402 of generating a query data based on the knowledge graph, wherein query data comprises a query corresponding to the brand. Further, the method 1400 may include a step 1404 of transmitting the query data to the large language model. Further, the method 1400 may include a step 1406 of receiving the response data from the large language model. Further, the response data is as response to the query.

Although the invention has been explained in relation to its preferred embodiment, it is to be understood that many other possible modifications and variations can be made without departing from the spirit and scope of the invention as hereinafter claimed.

What is claimed is:

1. A method of assessing a representation of a brand in language models, the method comprising:
generating, using a processing device, at least one query associated with at least one brand;
obtaining, using the processing device, at least one response from at least one pre-trained language model based on the at least one query;
retrieving, using a storage device, at least one brand information associated with the at least one brand;
analyzing, using the processing device, each of the at least one response and the at least one brand information using at least one machine learning (ML) model, wherein the at least one ML model is configured for:
processing the at least one response based on the at least one brand information; and
determining at least one value of at least one metric based on the processing;
generating, using the processing device, a representation score for the representation of the at least one brand based on the at least one value of the at least one metric; and
transmitting, using a communication device, the representation score to at least one brand device associated with the at least one brand.

2. The method of claim 1 further comprising:
receiving, using the communication device, at least one request from the at least one brand device, wherein the at least one request is for assessing the representation of the at least one brand; and
analyzing, using the processing device, the at least one request, wherein the generating of the at least one query is based on analyzing of the at least one request.

3. The method of claim 1 further comprising:
obtaining, using the processing device, at least one content associated with the at least one brand; and
analyzing, using the processing device, the at least one content using a second ML model, wherein the second ML model is configured for:
identifying a plurality of named entities and a plurality of entity associations among the plurality of named entities from the at least one content; and
generating at least one knowledge graph based on the plurality of named entities and the plurality of entity associations, wherein the at least one knowledge graph is comprised in the at least one brand information, wherein the at least one ML model is further configured for:
extracting a plurality of response-based named entities and a plurality of response-based entity associations among the plurality of response-based named entities from the at least one response based on the processing of the at least one response; and
evaluating each of the plurality of response-based named entities and the plurality of response-based entity associations in relation to the at least one knowledge graph, wherein the determining of the at least one value of the at least one metric is further based on the evaluating.

4. The method of claim 1, wherein the at least one pre-trained language model comprises at least one large language model (LLM), wherein the method further comprises:
transmitting, using the communication device, the at least one query to at least one external computing device configured to host the at least one LLM; and
receiving, using the communication, the at least one response from the at least one external computing device.

5. The method of claim 3, wherein the evaluating of each of the plurality of response-based named entities and the plurality of response-based entity associations in relation to the at least one knowledge graph comprises evaluating each of the plurality of response-based named entities and the plurality of response-based entity associations in relation to the at least one knowledge graph using at least one scoring engine module.

6. The method of claim 3, wherein the at least one metric comprises at least one of an entity overlap, a relationship overlap, and an inference accuracy associated with each of the plurality of response-based named entities and the plurality of response-based entity associations in relation to the at least one knowledge graph, wherein the entity overlap represents an equivalence associated with the plurality of named entities and the plurality of response-based named entities, wherein the relationship overlap represents the equivalence associated with the plurality of entity associations and the plurality of response-based entity associations.

7. The method of claim 1 further comprising:
determining, using the processing device, at least one of at least one similarity and at least one difference associated with the at least one response in relation to the at least one brand information based on the determining of the at least one value of the at least one metric;
generating, using the processing device, at least one evaluation report based on the determining of at least one of at least one similarity and at least one difference; and
transmitting, using the communication device, the at least one evaluation report to the at least one brand device.

8. The method of claim 3, wherein the plurality of named entities is represented as a plurality of nodes in the at least one knowledge graph, wherein the plurality of entity associations is represented as a plurality of edges in the at least one knowledge graph, wherein each of the plurality of edges connect a pair of nodes from the plurality of nodes to represent a semantic relationship among the pair of nodes.

9. The method of claim 3, wherein the generating of the at least one knowledge graph based on the plurality of named entities and the plurality of entity associations comprises generating the at least one knowledge graph based on the plurality of named entities and the plurality of entity associations using at least one knowledge graph builder module.

10. The method of claim 3 further comprises analyzing, using the processing device, the at least one response using at least one response analyzer module, wherein the extracting of the plurality of response-based named entities and the plurality of response-based entity associations by the at least one ML model is based on the analyzing of the at least one response using the response analyzer module.

11. A system of assessing a representation of a brand in language models, the system comprising:
a processing device configured for:
generating at least one query associated with at least one brand;
obtaining at least one response from at least one pre-trained language model based on the at least one query;
analyzing each of the at least one response and at least one brand information using at least one machine learning (ML) model, wherein the at least one ML model is configured for:
processing the at least one response based on the at least one brand information; and
determining at least one value of at least one metric based on the processing; and
generating a representation score for the representation of the at least one brand based on the at least one value of the at least one metric;
a storage device communicatively coupled with the processing device, wherein the storage device is configured for retrieving the at least one brand information associated with the at least one brand; and
a communication device communicatively coupled with the processing device, wherein the communication device is configured for transmitting the representation score to at least one brand device associated with the at least one brand.

12. The system of claim 11, wherein the communication device is further configured for receiving at least one request from the at least one brand device, wherein the at least one request is for assessing the representation of the at least one brand, wherein the processing device is further configured for analyzing the at least one request, wherein the generating of the at least one query is based on analyzing of the at least one request.

13. The system of claim 11, wherein the processing device is further configured for:
obtaining at least one content associated with the at least one brand; and
analyzing the at least one content using a second ML model, wherein the second ML model is configured for:
identifying a plurality of named entities and a plurality of entity associations among the plurality of named entities from the at least one content; and
generating at least one knowledge graph based on the plurality of named entities and the plurality of entity associations, wherein the at least one knowledge graph is comprised in the at least one brand information, wherein the at least one ML model is further configured for:
extracting a plurality of response-based named entities and a plurality of response-based entity associations among the plurality of response-based named entities from the at least one response based on the processing of the at least one response; and
evaluating each of the plurality of response-based named entities and the plurality of response-based entity associations in relation to the at least one knowledge graph, wherein the determining of the at least one value of the at least one metric is further based on the evaluating.

14. The system of claim 11, wherein the at least one pre-trained language model comprises at least one large language model (LLM), wherein the communication device is further configured for:
transmitting the at least one query to at least one external computing device configured to host the at least one LLM; and
receiving the at least one response from the at least one external computing device.

15. The system of claim 13, wherein the evaluating of each of the plurality of response-based named entities and the plurality of response-based entity associations in relation to the at least one knowledge graph comprises evaluating each of the plurality of response-based named entities and the plurality of response-based entity associations in relation to the at least one knowledge graph using at least one scoring engine module.

16. The system of claim 13, wherein the at least one metric comprises at least one of an entity overlap, a relationship overlap, and an inference accuracy associated with each of the plurality of response-based named entities and the plurality of response-based entity associations in relation to the at least one knowledge graph, wherein the entity overlap represents an equivalence associated with the plurality of named entities and the plurality of response-based named entities, wherein the relationship overlap represents the equivalence associated with the plurality of entity associations and the plurality of response-based entity associations.

17. The system of claim 11, wherein the processing device is further configured for:
determining at least one of at least one similarity and at least one difference associated with the at least one response in relation to the at least one brand information based on the determining of the at least one value of the at least one metric; and
generating at least one evaluation report based on the determining of at least one of at least one similarity and at least one difference, wherein the communication device is further configured for transmitting the at least one evaluation report to the at least one brand device.

18. The system of claim 13, wherein the plurality of named entities is represented as a plurality of nodes in the at least one knowledge graph, wherein the plurality of entity associations is represented as a plurality of edges in the at least one knowledge graph, wherein each of the plurality of edges connect a pair of nodes from the plurality of nodes to represent a semantic relationship among the pair of nodes.

19. The system of claim 13, wherein the generating of the at least one knowledge graph based on the plurality of named entities and the plurality of entity associations comprises generating the at least one knowledge graph based on the plurality of named entities and the plurality of entity associations using at least one knowledge graph builder module.

20. The system of claim 13, wherein the processing device is further configured for analyzing the at least one response using at least one response analyzer module, wherein the extracting of the plurality of response-based named entities and the plurality of response-based entity associations by the at least one ML model is based on the analyzing of the at least one response using the response analyzer module.
